(19) United States
(12) Patent Application Publication
(10) Pub. No.: US 2014/0101452 A1
(43) Pub. Date: Apr. 10, 2014

(54) METHOD AND TERMINAL FOR TRANSMITTING INFORMATION

(71) Applicant: Tencent Technology (Shenzhen) Company Limited, Shenzhen (CN)

(72) Inventors: Wen Tao WANG, Shenzhen (CN); Hong Da WU, Shenzhen (CN); Yuan XI, Shenzhen (CN); Mei HUANG, Shenzhen (CN)

(73) Assignee: Tencent Technology (Shenzhen) Company Limited, Shenzhen (CN)

(21) Appl. No.: 14/099,835

(22) Filed: Dec. 6, 2013

Related U.S. Application Data
(63) Continuation of application No. PCT/CN2013/084367, filed on Sep. 26, 2013.

(30) Foreign Application Priority Data
Sep. 27, 2012 (CN) 201210374431.5

(51) Int. Cl. H04L 9/08

(52) U.S. Cl. CPC H04L 9/0816
USPC 713/171; 709/227

(57) ABSTRACT

The present disclosure provides an information transmitting method and terminal for the same. The method can comprise: establishing a communication connection between an execution terminal and a command terminal into which an IM message is entered when the command terminal detects an information transmission request from the execution terminal; recording multimedia information by the execution terminal and sending the multimedia information from the execution terminal to the command terminal which has established the communication connection with the execution terminal; receiving the multimedia information by the command terminal and inserting the multimedia information by the command terminal into the IM message. The present disclosure can accomplish the transmission of multimedia information via inter-terminal interaction, thereby allowing a terminal into which an IM message is entered to obtain multimedia information from other terminals and increasing the convenience of using IM applications and the applications' rate of utilization.

### CROSS REFERENCE TO RELATED APPLICATION

This application is a U.S. continuation application under 35 U.S.C. §111(a) claiming priority, under 35 U.S.C. §120 and 365(c), to International Application No. PCT/CN2013/084367 filed on Sep. 26, 2013, which claims the priority benefit of Chinese Patent Application No. 201210374431.5, filed on Sep. 27, 2012, the contents of both the PCT application and the Chinese application are incorporated by reference herein in their entirety for all purposes.

### TECHNICAL FIELD

The present disclosure pertains generally to Internet and communication technology, specifically to the technological field of data processing, and more particularly, to a method and terminal for transmitting information in instant messaging (“IM”) applications.

### BACKGROUND

With the development of the IM technology, IM applications have been widely used. In addition to the traditional information exchange (e.g., text chat and text messaging), popular IM applications may include multimedia messaging exchange features such as audio chat, video chat, audio messaging, and video messaging. Often, a single terminal, such as a personal computer (“PC”), is responsible for processing information needed for a particular IM application. For example, if a user wants to use an IM application for audio chat or audio messaging on a PC, the user must first install compatible hardware, such as a microphone, which records audio messages on the PC. Similarly, if the user wants to use an IM application for video chat or video messaging, the user must first install compatible hardware, such as a camera or a webcam, which records video messages on the PC. Currently, Wi-Fi capable and/or Bluetooth capable cameras or webcams can be installed on a PC. However, because of the diversity of the configurations of terminal devices for personal use, not all terminals are equipped with recording hardware, such as a microphone, a camera, or a webcam. Moreover, even if such hardware is available on PC terminals, it may be cumbersome to use as the PC itself may not be compact and mobile. In contrast, many mobile devices, such as mobile phones, have integrated recording hardware. For example, the iPhone has two cameras, one on the same side as the screen facing the user, which could be referred to as a webcam, and the other facing the opposite side of the screen. Both cameras can capture images as well as record video messages. The iPhone also has a speaker and a microphone, which can record audio messages. Moreover, the recording hardware and associated software vary on different mobile phones. For example, the Software development kit (“SDK”) for iOS, the operating system that runs on iPhone, has an application programming interface (“API”) facilitating the information capture by the recording hardware on the iPhone. IM application providers have long sought a technical solution that allows PC terminals to generate multimedia IM messages containing multimedia information obtained by the recording hardware on mobile devices.

### SUMMARY OF THE DISCLOSURE

Embodiments of the present disclosure provide methods and terminals for transmitting information where the communication between the terminals allows the transmission of multimedia information. As a result, the terminal, into which an IM message is entered, is able to insert multimedia information sent from other terminals into the IM message, thereby increasing the convenience of using IM applications and the applications' rate of utilization.

An embodiment provides a method for transmitting information. The method comprises:

A command terminal, into which an IM message is entered, detects an information transmission request from an execution terminal and establishes a communication connection with the execution terminal;

The execution terminal records multimedia information and sends the multimedia information to the command terminal, which has established a communication connection with the execution terminal; and

The command terminal receives the multimedia information and inserts the multimedia information into the IM message.

Another embodiment provides a method for transmitting information. The method comprises:

A command terminal, into which an IM message is entered, detects an information transmission request from an execution terminal and establishes a communication connection with the execution terminal;

The command terminal receives multimedia information, which was obtained by and sent from the execution terminal; and

The command terminal inserts the multimedia information into the IM message.

A third embodiment provides a method for transmitting information. The method comprises:

An execution terminal sends an information transmission request to a command terminal, into which an IM message is entered;

Upon establishing a communication connection with the command terminal, the execution terminal records multimedia information; and

The execution terminal sends the multimedia information to the command terminal, and the command terminal inserts the multimedia information into the IM message.

A fourth embodiment provides a command terminal. The command terminal comprises:

A connection establishing module that detects an information transmission request from an execution terminal and establishes a communication connection between the command terminal, into which an IM message is entered, and the execution terminal;

A transmission module that receives multimedia information, which was obtained by and sent from the execution terminal; and

A processing module that inserts the multimedia information into the IM message.

A fifth embodiment provides an execution terminal. The execution terminal comprises:

A request module that sends an information transmission request to a command terminal, into which an IM message is entered;

A connection establishing module that establishes a communication connection between the command terminal and the execution terminal;

A recording module that activates recording hardware to record multimedia information after the communication connection between the command terminal and the execution terminal is established; and

A transmission module that sends multimedia information to the command terminal, which then inserts the multimedia information into the IM message.

A sixth embodiment provides a computer-readable storage medium storing one or more computer programs, which when executed by one or more computers, causes the one or more computers to carry out some or all of the steps in the above-described embodiments, in part or in whole, in accordance with the disclosure described hereinabove.

According to embodiments of the present disclosure, a command terminal, into which an IM message is entered, can establish a communication connection with an execution terminal for transmitting information. As a result, the command terminal can obtain multimedia information recorded by the execution terminal. The command terminal then can insert the multimedia information in the IM message. Thus, the command terminal can take advantage of the multimedia features in IM applications without installing additional recording hardware, such as a microphone, a camera, or a webcam, thereby reducing or eliminating the cost for installing recording hardware on the command terminal. Moreover, the utility of IM applications on a command terminal will not be affected by the immobility of the command terminal, thereby increasing the convenience of using the IM applications and the applications' rate of utilization.

### BRIEF DESCRIPTION OF THE DRAWINGS

Exemplary embodiments of the present disclosure are described below in detail with reference to the accompanying drawings.

FIG. 1 is a flowchart illustrating an example of the flow of a method for transmitting information according to various embodiments.

FIG. 2 is a flowchart illustrating an example of the flow of a method for transmitting information according to various embodiments.

FIG. 3 is a flowchart illustrating an example of the flow of a method for transmitting information according to various embodiments.

FIG. 4 is a flowchart illustrating an example of the flow of a method for transmitting information according to various embodiments.

FIG. 5 is a flowchart illustrating an example of the flow of a method for transmitting information according to various embodiments.

FIG. 6 is a flowchart illustrating an example of the flow of a method for transmitting information according to various embodiments.

FIG. 7 is a flowchart illustrating an example of the flow of a method for transmitting information according to various embodiments.

FIG. 8 is a schematic diagram illustrating an example of an arrangement of a command terminal according to various embodiments.

FIG. 9 is a schematic diagram illustrating an example of an arrangement of a connection establishing module illustrated in FIG. 8.

FIG. 10 is a schematic diagram illustrating another example of an arrangement of a connection establishing module illustrated in FIG. 8.

FIG. 11 is a schematic diagram illustrating an example of an arrangement of a transmission module illustrated in FIG. 8.

FIG. 12 is a schematic diagram illustrating another example of an arrangement of a command terminal according to various embodiments.

FIG. 13 is a schematic diagram illustrating an example of an arrangement of an execution terminal according to various embodiments.

FIG. 14 is a schematic diagram illustrating an example of an arrangement of a connection establishing module illustrated in FIG. 13.

FIG. 15 is a schematic diagram illustrating another example of an arrangement of a connection establishing module illustrated in FIG. 13.

FIG. 16 is a schematic diagram illustrating an example of an arrangement of a transmission module illustrated in FIG. 13.

### DETAILED DESCRIPTION

Exemplary embodiments of the present disclosure are described below in detail with reference to the figures. The selected embodiments are merely exemplary and may not be used to limit the present disclosure. Embodiments obtained by person having ordinary skill in the art without inventive activity are within the scope of this disclosure.

Examples of terminals include, but are not limited to, a PC, a tablet PC (including, but not limited to, Apple iPad and other touch-screen devices running Apple iOS, Microsoft Surface and other touch-screen devices running the Windows operating system, and tablet devices running the Android operating system), a mobile phone, a smartphone (including, but not limited to, an Apple iPhone, a Windows Phone and other smartphones running Windows Mobile or Pocket PC operating systems, and smartphones running the Android operating system, the Blackberry operating system, or the Symbian operating system), an e-reader (including, but not limited to, Amazon Kindle and Barnes & Noble Nook), a laptop computer (including, but not limited to, computers running Apple Mac operating system, Windows operating system, Android operating system and/or Google Chrome operating system), or an on-vehicle device or a smart television or any smart device running any of the above-mentioned operating systems or any other operating systems, all of which are well known to those skilled in the art. As used herein, a “command terminal” refers to a terminal, into which an IM message is entered. The command terminal can be any terminal discussed above. As used herein, an “execution terminal” refers to a terminal that sends an information transmission request and records multimedia information to be sent. The execution terminal can be any terminal discussed above, preferably one containing recording hardware, such as a microphone, a camera, and/or a webcam.

Examples of recording hardware include, but are not limited to, microphones, cameras, tape recorders, digital voice recorders, video recorders, webcams and other devices capable of recording multimedia information. Examples of multimedia information include, but are not limited to, audio information, images, video information, and any combination thereof. As used herein, “address information” is any information by which the identity and/or location of a terminal can be ascertained on the Internet. A preferred example of address information is the Internet Protocol (“IP”) address. For example, address information associated with a command terminal is the IP address of the command terminal, and address information associated with an execution terminal is the IP address of the execution terminal. As used herein, “secret key information” refers to information used by a specific terminal to securely establish a communication connection with another terminal, such that only a terminal that has received the secret key information associated with the specific terminal can establish a communication connection with the specific terminal. Methods of securely connecting two terminals using secret key information are well known to those skilled in the art. According to some embodiments, a second terminal can, after receiving the secret key information of a first terminal, send a first data packet to the first terminal, either directly or via a local area network (“LAN”) communication port, wherein the first data packet comprises the received secret key information and address information associated with the second terminal. After receiving the first data packet, either directly or via the LAN communication port, the first terminal can verify the secret key information in the first data packet, and send a connection response data packet to the second terminal in accordance with the address information associated with the second terminal after and only after the verification is successful, i.e., the secret key information in the first data packet is the same as the secret key information previously sent out from the first terminal. According to some other embodiments, a second terminal can, after receiving the secret key information of a first terminal, encrypt a second data packet using the secret key information and send the second data packet to the first terminal, either directly or via a LAN communication port, wherein the second connection request data packet comprises address information associated with the second terminal. After receiving the encrypted second data packet, the first terminal can decrypt the encrypted second data packet using the secret key information associated with the first terminal and send a second connection response data packet to the second terminal in accordance with the address information associated with the second terminal after and only after a successful decryption.

The multimedia information, which is being recorded by one terminal, can be instantly transmitted to the other terminal. For example, in the PC-mobile device example discussed above, there can be a predefined size limit for data transfer between the two terminals. When the recorded multimedia information reaches the predefined size limit, it can be sent to the PC, where it can be cached. As the recording hardware continues recording, subsequent pieces of multimedia information can be generated by and sent from the mobile device, and cached by the PC. At the end of a recording session, the mobile device will send the PC a notification signaling the completion of the recording session. When the PC receives the notification, it combines all of the cached multimedia information to generate complete multimedia information, which can be used in software applications, such as being inserted into a message in an instant messaging application. Currently, standard technologies are available to facilitate compressing, encrypting, decrypting, and transferring or transmitting of multimedia information. There are also standards available to work with different operating systems on these terminals and facilitate the formation of a communication connection and subsequent information exchange between terminals.

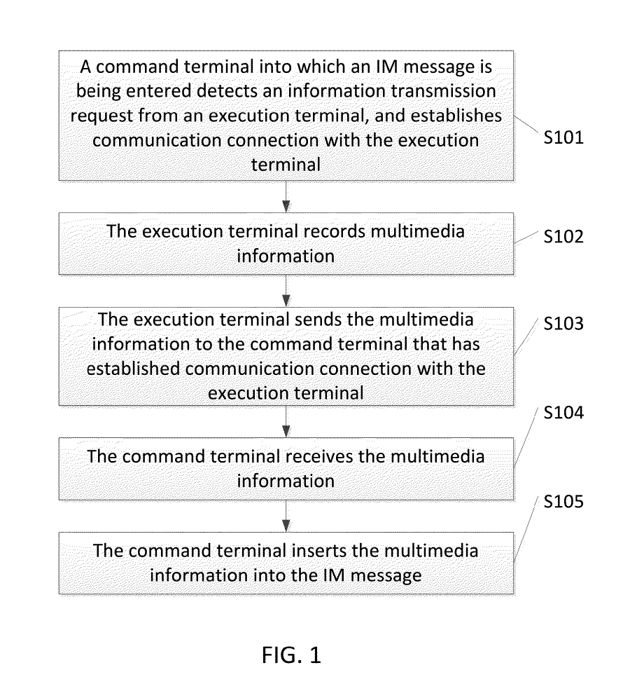

The detailed description of embodiments of the present disclosure with respect to a method for transmitting information, with references to FIGS. 1-7, is as follows:

FIG. 1 is a flowchart illustrating an example of the flow of a method for transmitting information according to various embodiments. FIG. 1 depicts a method for transmitting information carried out through a communication connection between a command terminal and an execution terminal. The method comprises:

S101: a command terminal, into which an IM message is entered, detects an information transmission request from an execution terminal and establishes a communication connection with the execution terminal;

According to some embodiments, the communication connection between the command terminal and the execution terminal is a LAN connection, such as a wireless LAN connection. The LAN connection can increase the rate of information transmission and ensure the reliability of information transmission. According to some embodiments, in order to detect an information transmission request sent from an execution terminal, a command terminal, into which an IM message is entered, can listen to a particular network port, e.g., a LAN communication port. If the command terminal detects such a request, it can establish a communication connection with the execution terminal that sent the request.

S102: the execution terminal records multimedia information and sends the multimedia information to the command terminal that has established the communication connection with the execution terminal;

According to some embodiments, the execution terminal can activate recording hardware to record the multimedia information. For example, a microphone can record audio information, and a webcam can record video information. The execution terminal can send the recorded multimedia information to the command terminal that has established the communication connection with the execution terminal.

S103: the command terminal receives the multimedia information and inserts the multimedia information into the IM message.

According to some embodiments, the command terminal inserts the multimedia information into the IM message, and the multimedia information becomes a part of the content of the IM message. As such, by using recording hardware on the execution terminal, the command terminal is able to obtain multimedia content for an IM message that is entered.

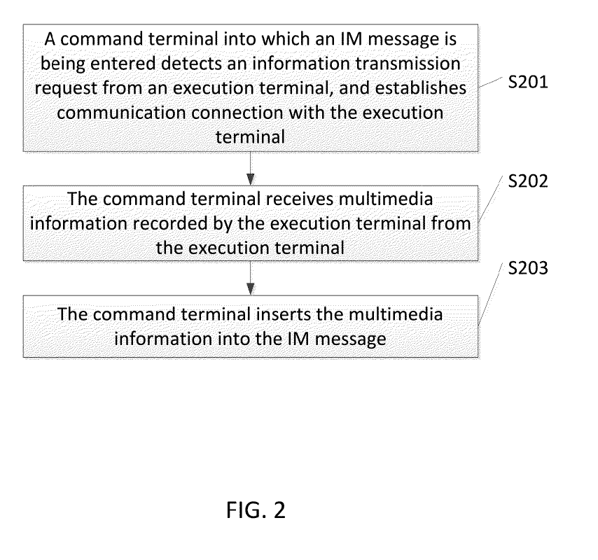

FIG. 2 is a flowchart illustrating an example of the flow of a method for transmitting information according to various embodiments. FIG. 2 depicts a method for transmitting information executed by a command terminal. The method comprises:

S201: a command terminal, into which an IM message is entered, detects an information transmission request from an execution terminal and establishes a communication connection with the execution terminal;

S202: The command terminal receives multimedia information, which was obtained by and sent from the execution terminal; and

S203: the command terminal inserts the multimedia information into the IM message.

Details related to S201 to S203 in this example are substantially similar, if not identical, to S101 to S103 in the example shown in FIG. 1 and are not repeated here.

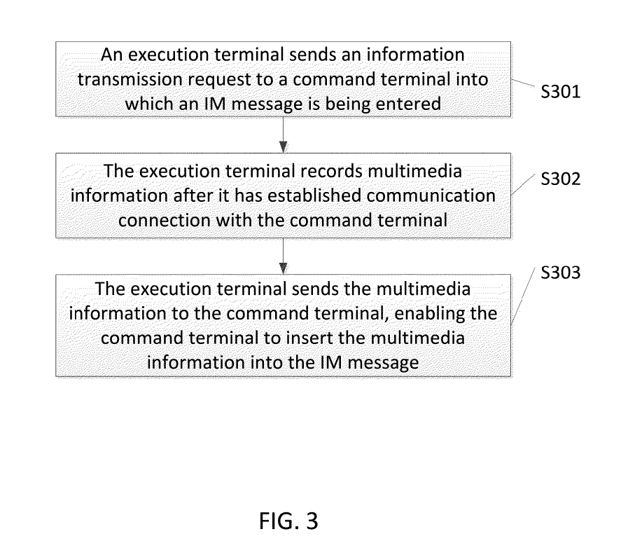

FIG. 3 is a flowchart illustrating an example of the flow of a method for transmitting information according to various embodiments. FIG. 3 depicts a method for transmitting information executed by an execution terminal. The method comprises:

S301: an execution terminal sends an information transmission request to a command terminal, into which an IM message is entered;

According to some embodiments, the execution terminal sends the information transmission request to the command terminal by broadcasting the request via a particular network port, such as a LAN communication port.

S302: after establishing a communication connection with the command terminal, the execution terminal records multimedia information;

According to some embodiments, the execution terminal can activate recording hardware to record the multimedia information. For example, a microphone can record audio information, and a webcam can record video information.

S303: the execution terminal sends the multimedia information to the command terminal, and the command terminal inserts the multimedia information into the IM message.

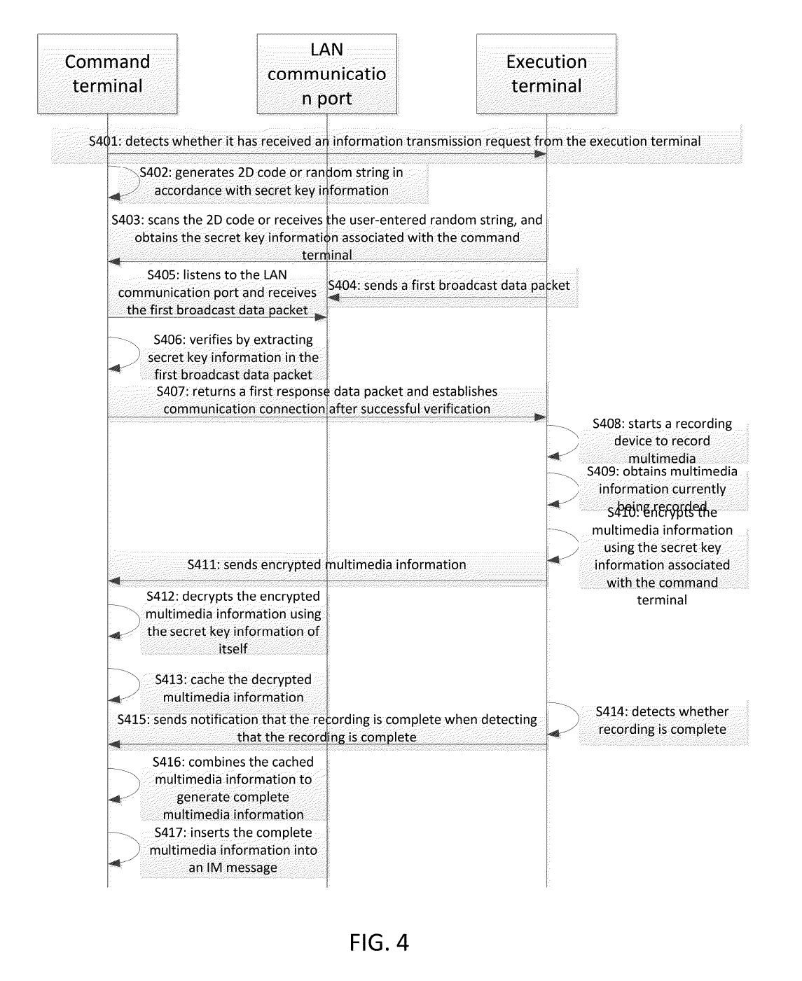

FIG. 4 is a flowchart illustrating an example of the flow of a method for transmitting information according to various embodiments. FIG. 4 depicts a method for transmitting information carried out through a communication connection between a command terminal and an execution terminal. The method comprises:

S401: a command terminal, into which an IM message is entered, detects whether it has received an information transmission request from an execution terminal. If so, it proceeds to S402;

Details related to S401 in this example are substantially similar, if not identical, to S101 in the example shown in FIG. 1 and are not repeated here.

S402: the command terminal generates a two-dimensional (“2D”) code, such as a 2D barcode, or a random string, in accordance with secret key information associated with the command terminal;

S403: by scanning the 2D code or receiving the random string entered by a user, the execution terminal obtains the secret key information associated with the command terminal;

According to some embodiments, utilizing a 2D code, such as a 2D barcode, or a random string representing secret key information associated with a command terminal allows fast and convenient access to the secret key information.

S404: the execution terminal sends a first broadcast data packet to a LAN communication port, wherein the first broadcast data packet contains the secret key information associated with the command terminal and address information associated with the execution terminal. According to some embodiments, the first broadcast data packet can be a User Datagram Protocol (“UDP”) packet;

S405: the command terminal listens to the LAN communication port and receives the first broadcast data packet;

S406: the command terminal extracts the secret key information from the first broadcast data packet and verifies it;

According to some embodiments, the verification process by the command terminal includes comparing secret key information associated with the command terminal with the secret key information extracted from the first broadcast data packet. The verification process succeeds if the two are identical; otherwise, the verification process fails. The verification process ensures the reliability of the subsequent multimedia information transmission.

S407: after successful verification, utilizing the address information associated with the execution terminal that is included in the first broadcast data packet, the command terminal returns a first response data packet to the execution terminal and establishes a communication connection with the execution terminal;

S408: the execution terminal activates recording hardware to start recording multimedia information. For example, a microphone can record audio information, and a webcam can record video information;

S409: the execution terminal obtains the multimedia information currently being recorded;

S410: using the secret key information associated with the command terminal, the execution terminal encrypts the multimedia information currently being recorded;

According to some embodiments, the encryption of the multimedia information, which is done after the execution terminal obtains the multimedia information currently being recorded but before the execution terminal sends the multimedia information, ensures the security of electronic data transmission.

S411: the execution terminal sends the encrypted multimedia information to the command terminal;

S409 to S411 illustrate a process of recording and transmitting multimedia information where the execution terminal sends one piece of multimedia information to the command terminal while the next piece of multimedia information is currently being recorded. In practice, the size of multimedia information that can be sent at one time is usually predefined. When the size of multimedia information being recorded reaches the predefined limit, the execution terminal can encrypt and send a first piece of multimedia information to the command terminal. When the first piece of multimedia information is being sent, the next piece can be recorded. This process continues until the entire multimedia information is recorded and sent. This process reduces the demand on cache memory on the execution terminal, and limiting the data size improves the efficiency of data transmission. In practice, the execution terminal may use Transmission Control Protocol (“TCP”) or Hypertext Transfer Protocol (“HTTP”) to send the encrypted multimedia information to the command terminal.

S412: the command terminal decrypts the encrypted multimedia information from the execution terminal by using the secret key information associated with the command terminal;

S413: the command terminal caches the decrypted multimedia information;

S414: the execution terminal determines whether recording of the multimedia information is completed. In the event that a recording session is complete, it proceeds to S415;

According to some embodiments, the execution terminal monitors a user's activities during the recording session and determines whether the current session is complete. For example, a recording session can be deemed to be complete if the execution terminal detects that a user turns off the recording device or clicks or taps a button indicating the end of the recording session.

S415: upon determining that the recording of the multimedia information is complete, the execution terminal sends a notification to the command terminal indicating that the recording has ended;

S416: upon receipt of the notification, the command terminal combines the cached multimedia information to generate complete multimedia information; and

S417: the command terminal inserts the complete multimedia information into the IM message.

In steps S415 to S417, when receiving the notification, the command terminal learns that the recording session has ended. Thereafter, the command terminal combines the cached multimedia information to generate complete multimedia information and inserts the complete multimedia information into the IM message. Because the complete multimedia information is inserted in the IM message, the integrity of the IM message is ensured, thereby making it convenient for a user to browse the information.

The following is a specific example illustrating an embodiment of a method for transmitting information in accordance with the present disclosure.

Assume that the command terminal is a PC, into which an IM message is entered, and the execution terminal is a mobile phone. Both the PC and the mobile phone are connected to the same LAN. If the PC user intends to use a microphone on the mobile phone to record audio information and include the audio information in the IM message, the audio information can be sent from the mobile phone to the PC. The information transmission method for this embodiment can comprise the following steps:

To detect an information transmission request from the mobile phone, the PC listens to a LAN communication port. If the PC detects such request, it generates a 2D code or a random string in accordance with secret key information associated with the PC. The mobile phone obtains the secret key information associated with the PC by scanning the 2D code or receiving the random string entered by a user. The mobile phone sends a first broadcast data packet to the PC, wherein the first broadcast data packet contains the secret key information associated with the PC and IP address information associated with the mobile phone. The PC listens to the LAN communication port and receives the first broadcast data packet, and then it extracts the secret key information from the first broadcast data packet and verifies it. After successful verification, utilizing the IP address information associated with the mobile phone that is included in the first broadcast data packet, the PC returns a first response data packet to the mobile phone and establishes a wireless LAN communication connection with the mobile phone.

The mobile phone activates a microphone to start recording audio information. The mobile phone encrypts the audio information currently being recorded using the secret key information associated with the PC. Then, the mobile phone sends the encrypted audio information to the PC. Using the secret key information, the PC decrypts the encrypted audio information from the mobile phone and caches the decrypted audio information. After determining that recording of the audio information is complete, the mobile phone sends a notification to the PC indicating that the recording has ended. The PC then combines the cached audio information to generate complete audio information and inserts the complete audio information into the IM message.

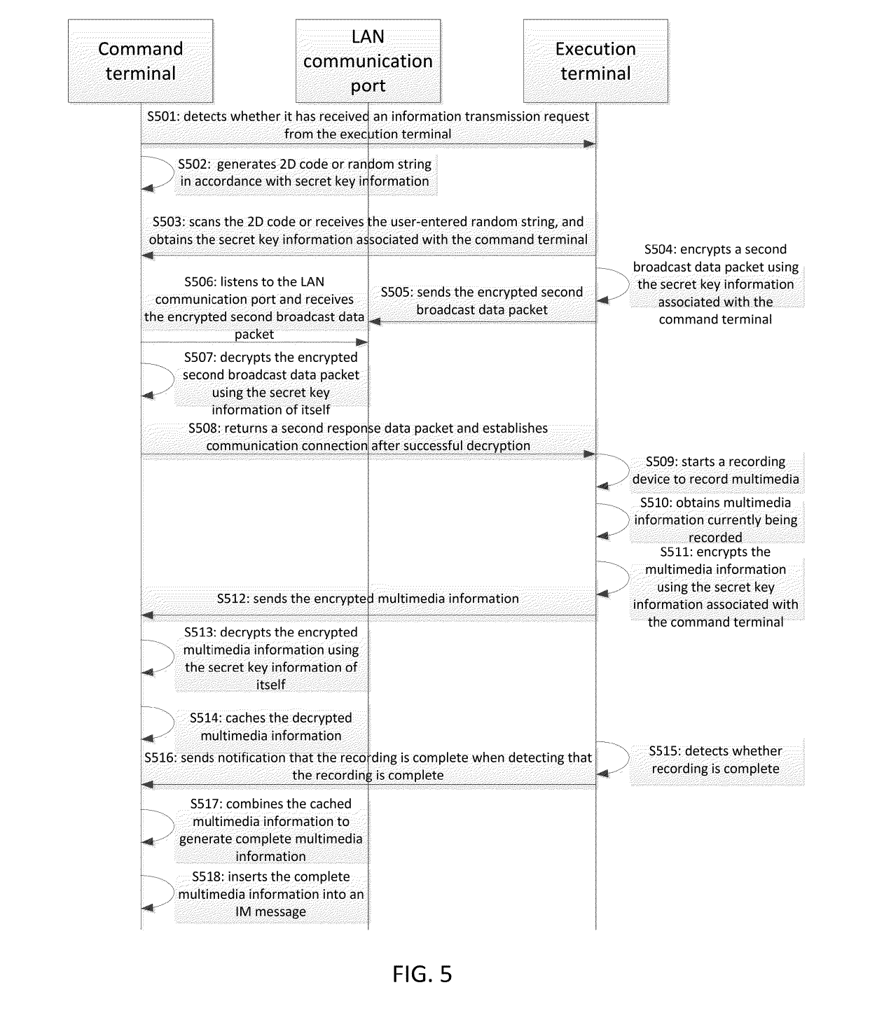

FIG. 5 is a flowchart illustrating an example of the flow of a method for transmitting information according to various embodiments. FIG. 5 depicts a method for transmitting information carried out through a communication connection between a command terminal and an execution terminal. The method comprises:

S501: a command terminal, into which an IM message is entered, detects whether it has received an information transmission request from an execution terminal. If so, it proceeds to S502;

S502: the command terminal generates a 2D code, such as a 2D barcode, or a random string in accordance with secret key information associated with the command terminal;

S503: by scanning the 2D code or receiving the random string entered by a user, the execution terminal obtains the secret key information associated with the command terminal;

Details related to S501 to S503 in this example are substantially similar, if not identical, to S401 to S403 in the example shown in FIG. 4 and are not repeated here.

S504: using secret key information associated with the command terminal, the execution terminal encrypts a second broadcast data packet, which contains address information associated with the execution terminal;

S505: the execution terminal sends the encrypted second broadcast data packet to a LAN communication port;

S506: the command terminal listens to the LAN communication port and receives the encrypted second broadcast data packet;

S507: the command terminal decrypts the encrypted second broadcast data packet from the execution terminal using the secret key information associated with the command terminal;

S508: after successful decryption, utilizing the address information associated with the execution terminal, which is included in the second broadcast data packet, the command terminal returns a second response data packet to the execution terminal and establishes a communication connection with the execution terminal;

S509: the execution terminal activates recording hardware to start recording multimedia information;

S510: the execution terminal obtains the multimedia information currently being recorded;

S511: using the secret key information associated with the command terminal, the execution terminal encrypts the multimedia information currently being recorded;

S512: the execution terminal sends the encrypted multimedia information to the command terminal;

S513: the command terminal decrypts the encrypted multimedia information from the execution terminal by using the secret key information associated with the command terminal;

S514: the command terminal caches the decrypted multimedia information;

S515: the execution terminal determines whether recording of the multimedia information is complete. In the event that the recording session is complete, it proceeds to S516;

S516: upon determining that the recording of the multimedia information is complete, the execution terminal sends a notification to the command terminal indicating that the recording has ended;

S517: upon receipt of the notification, the command terminal combines the cached multimedia information to generate complete multimedia information; and

S518: the command terminal inserts the complete multimedia information into the IM message.

Details related to S509 to S518 in this example are substantially similar, if not identical, to S408 to S417 in the example shown in FIG. 4 and are not repeated here.

The following is a specific example illustrating an embodiment of a method for transmitting information in accordance with the present disclosure.

Assume that the command terminal is a PC, into which an IM message is entered, and execution terminal is a mobile phone. Both the PC and the mobile phone are connected to the same LAN. If the PC user intends to use a webcam on the mobile phone to record video information and include the video information in the IM message, the video information can be sent from the mobile phone to the PC. The information transmission method for this embodiment can comprise the following steps:

To detect an information transmission request, the PC listens to a LAN communication port. If the PC detects such request, it generates a 2D code or a random string in accordance with secret key information associated with the PC. The mobile phone obtains the secret key information associated with the PC by scanning the 2D code or receiving the random string entered by a user. Using the secret key information associated with the PC, the mobile phone encrypts a second broadcast data packet, which contains IP address information associated with the mobile phone. The mobile phone then sends the encrypted second broadcast data packet to the PC. The PC listens to the LAN communication port and receives the encrypted second broadcast data packet. The PC then decrypts the encrypted second broadcast data packet using the secret key information associated with the PC. After successful decryption, utilizing the IP address information associated with the mobile phone that is included in the second broadcast data packet, the PC returns a second response data packet to the mobile phone and establishes a wireless LAN communication connection with the mobile phone.

The mobile phone activates a webcam to start recording video information. The mobile phone encrypts the video information currently being recorded using the secret key information associated with the PC. Then, the mobile phone sends the encrypted video information to the PC. Using the secret key information, the PC decrypts the encrypted video information from the mobile phone and caches the decrypted video information. After determining that recording of the video information is complete, the mobile phone sends a notification to the PC indicating that the recording has ended. The PC then combines the cached video information to generate complete video information and inserts the complete video information into the IM message.

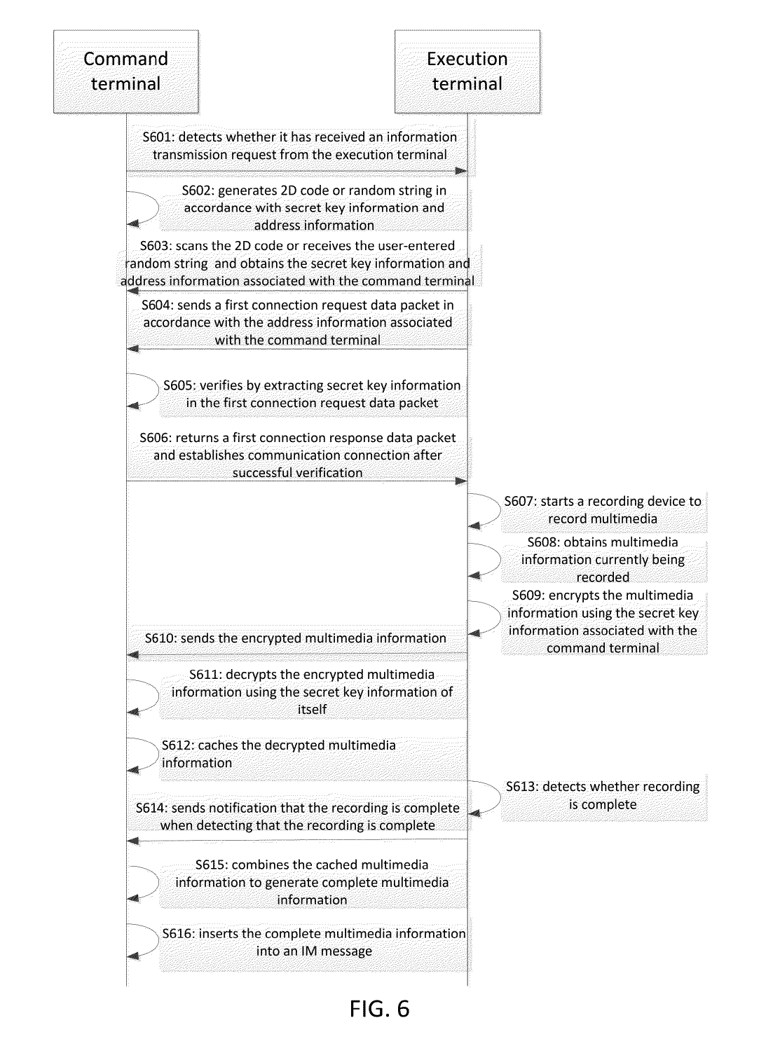

FIG. 6 is a flowchart illustrating an example of the flow of a method for transmitting information according to various embodiments. FIG. 6 depicts a method for transmitting information carried out through a communication connection between a command terminal and an execution terminal. The method comprises:

S601: a command terminal, into which an IM message is entered, detects whether it has received an information transmission request from an execution terminal. If so, it proceeds to S602;

S602: the command terminal generates a 2D code, such as a 2D barcode, or a random string in accordance with secret key information and address information associated with the command terminal;

S603: by scanning the 2D code or receiving the random string entered by a user, the execution terminal obtains the secret key information and the address information associated with the command terminal;

S604: in accordance with the address information associated with the command terminal, the execution terminal sends a first connection request data packet to the command terminal, wherein the first connection request data packet contains the secret key information associated with command terminal and address information associated with the execution terminal;

S605: the command terminal extracts the secret key information from the first connection request data packet and verifies it;

S606: after successful verification, utilizing the address information associated with the execution terminal that is included in the first connection request data packet, the command terminal returns a first connection response data packet to the execution terminal and establishes a communication connection with the execution terminal;

S607: the execution terminal activates recording hardware to start recording multimedia information;

S608: the execution terminal obtains the multimedia information currently being recorded;

S609: using the secret key information associated with the command terminal, the execution terminal encrypts the multimedia information currently being recorded;

S610: the execution terminal sends the encrypted multimedia information to the command terminal;

S611: the command terminal decrypts the encrypted multimedia information from the execution terminal by using the secret key information associated with the command terminal;

S612: the command terminal caches the decrypted multimedia information;

S613: the execution terminal determines whether recording of the multimedia information is complete. In the event that the recording session is complete, it proceeds to S614;

S614: upon determining that the recording of the multimedia information is complete, the execution terminal sends a notification to the command terminal indicating that the recording has ended;

S615: upon receipt of the notification from the execution terminal, the command terminal combines the cached multimedia information to generate complete multimedia information; and

S616: the command terminal inserts the complete multimedia information into the IM message.

The difference between this example and that shown in FIG. 4 lies in that, in this example, the 2D code or the random string generated by the command terminal contains not only the secret key information but also the address information associated with the command terminal. Then, by scanning the 2D code or receiving the random string entered by the user, the execution terminal obtains the secret key information and the address information associated with the command terminal, which enables the execution terminal to establish the communication connection with the command terminal based on the address information associated with the command terminal.

The following is a specific example illustrating an embodiment of a method for transmitting information in accordance with the present disclosure.

Assume that the command terminal is a PC into which an IM message is entered, and execution terminal is a mobile phone. Both the PC and the mobile phone are connected to the same LAN. If the PC user intends to use a microphone on the mobile phone to record audio information and include the audio information in the IM message, the audio information can be sent from the mobile phone to the PC. The information transmission method for this embodiment can comprise the following steps:

To detect an information transmission request, the PC listens to a LAN communication port. If the PC detects such request, it generates a 2D code or a random string in accordance with secret key information and address information associated with the PC. The mobile phone obtains the secret key information and the address information associated with the PC by scanning the 2D code or receiving the random string entered by a user. In accordance with the IP address information associated with the PC, the mobile phone sends a first connection request data packet to the PC, wherein the first connection request data packet contains the secret key information associated with the PC and address information associated with the mobile phone. The PC receives the first connection request data packet, and then extracts the secret key information from the first connection request data packet and verifies it. After successful verification, utilizing the mobile phone's IP address information that is included in the first connection request data packet, the PC returns a first connection response data packet to the mobile phone and establishes a wireless LAN communication connection with the mobile phone.

The mobile phone activates a microphone to start recording audio information. The mobile phone encrypts the audio information currently being recorded using the secret key information associated with the PC. Then, the mobile phone sends the encrypted audio information to the PC. Using the secret key information, the PC decrypts the encrypted audio information from the mobile phone and caches the decrypted audio information. After determining that recording of the audio information is complete, the mobile phone sends a notification to the PC indicating that the recording has ended. The PC then combines the cached audio information to generate complete audio information and inserts the complete audio information into the IM message.

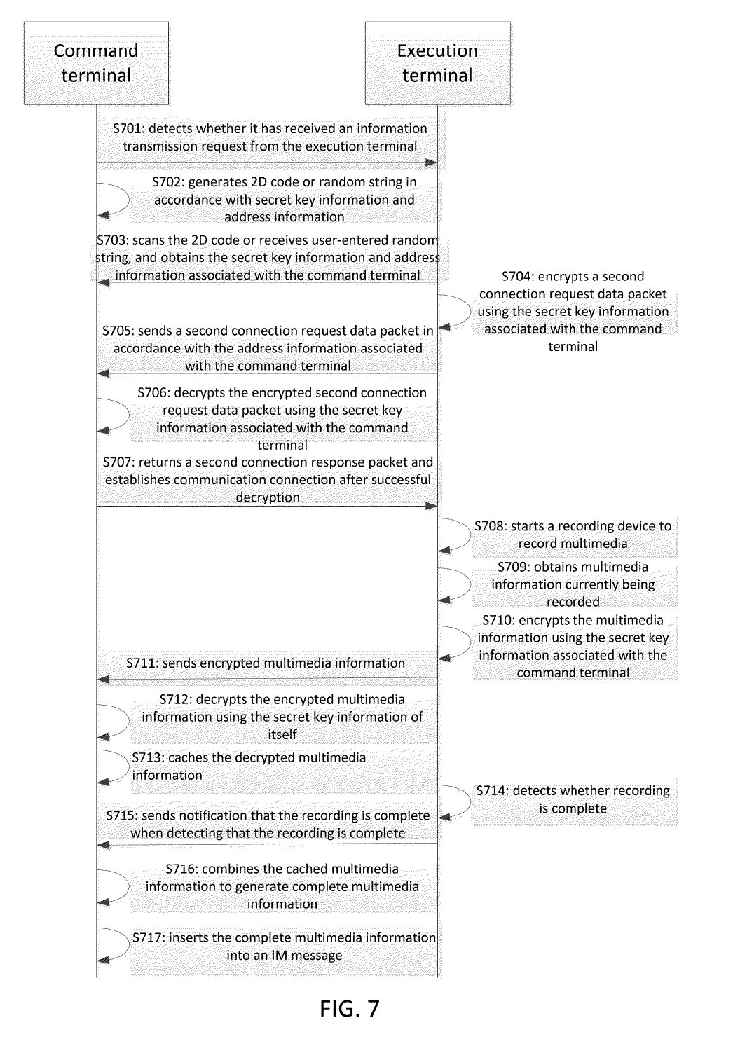

FIG. 7 is a flowchart illustrating an example of the flow of a method for transmitting information according to various embodiments. FIG. 7 depicts a method for transmitting information carried out through a communication connection between a command terminal and an execution terminal. The method comprises:

S701: a command terminal, into which an IM message is entered, detects whether it has received an information transmission request from an execution terminal. If so, it proceeds to S702;

S702: the command terminal generates a 2D code, such as a 2D barcode, or a random string, in accordance with secret key information and address information associated with the command terminal;

S703: by scanning the 2D code or receiving the random string entered by a user, the execution terminal obtains the secret key information and the address information associated with the command terminal;

S704: using the secret key information associated with the command terminal, the execution terminal encrypts a second connection request data packet, which contains address information associated with the execution terminal;

S705: in accordance with the address information associated with the command terminal, the execution terminal sends the encrypted second connection request data packet to the command terminal;

S706: the command terminal decrypts the encrypted second connection request data packet using the secret key information associated with the command terminal;

S707: after successful decryption, utilizing the address information associated with the execution terminal that is included in the second connection request data packet, the command terminal returns a second connection response data packet to the execution terminal and establishes a communication connection with the execution terminal;

S708: the execution terminal activates recording hardware to start recording multimedia information;

S709: the execution terminal obtains multimedia information currently being recorded;

S710: using the secret key information associated with the command terminal, the execution terminal encrypts the multimedia information currently being recorded;

S711: the execution terminal sends the encrypted multimedia information to the command terminal;

S712: the command terminal decrypts the encrypted multimedia information from the execution terminal by using the secret key information associated with the command terminal;

S713: the command terminal caches the decrypted multimedia information;

S714: the execution terminal determines whether recording of the multimedia information is complete. In the event that the recording session is complete, it proceeds to S715;

S715: upon determining that the recording of the multimedia information is complete, the execution terminal sends a notification to the command terminal indicating that the recording has ended;

S716: upon receipt of the notification from the execution terminal, the command terminal combines the cached multimedia information to generate complete multimedia information; and

S717: the command terminal inserts the complete multimedia information into the IM message.

The difference between this example and that shown in FIG. 5 lies in that the 2D code or the random string generated by the command terminal contains not only the secret key information but also the address information associated with the command terminal. Then, by scanning the 2D code or receiving the random string entered by the user, the execution terminal obtains the secret key information and the address information associated with the command terminal, which enables the execution terminal to establish the communication connection with the command terminal based on the address information associated with the command terminal.

The following is a specific example illustrating an embodiment of a method for transmitting information in accordance with the present disclosure.

Assume that the command terminal is a PC, into which an IM message is entered, and the execution terminal is a mobile phone. Both the PC and the mobile phone are connected to the same LAN. If the PC user intends to use a webcam on the mobile phone to record video information and include the video information in the IM message, the video information can be sent from the mobile phone to the PC. The information transmission method for this embodiment can comprise the following steps:

To detect an information transmission request, the PC listens to a LAN communication port. If the PC detects such request, it generates a 2D code or a random string in accordance with secret key information and address information associated with the PC. The mobile phone obtains the secret key information and the address information associated with the PC by scanning the 2D code or receiving the random string entered by a user. Using the secret key information associated with the PC, the mobile phone encrypts a second connection request data packet, which contains IP address information associated with the mobile phone. In accordance with the IP address information associated with the PC, the mobile phone sends the encrypted second connection request data packet to the PC. The PC receives the encrypted second connection request data packet. The PC decrypts the encrypted second connection request data packet using the secret key information associated with the PC. After successful decryption, utilizing the IP address information associated with the mobile phone that is included in the second connection request data packet, the PC returns a second connection response data packet to the mobile phone and establishes a wireless LAN communication connection with the mobile phone.

The mobile phone activates a webcam to start recording video information. The mobile phone encrypts the video information currently being recorded using the secret key information associated with the PC. Then, the mobile phone sends the encrypted video information to the PC. Using the secret key information, the PC decrypts the encrypted video information from the mobile phone and caches the decrypted video information. After determining that recording of the video information is complete, the mobile phone sends a notification to the PC indicating that the recording has ended. The PC then combines the cached video information to generate complete video information and inserts the complete video information into the IM message.

The above description of embodiments concerning a method for transmitting information illustrates that, according to embodiments of the present disclosure, a command terminal, into which an IM message is entered, can establish a communication connection with an execution terminal for transmitting multimedia information. As a result, the command terminal can obtain multimedia information recorded by the execution terminal and insert the multimedia information into the IM message. Thus, the command terminal can take advantage of the multimedia features in IM applications without installing additional recording hardware, such as a microphone, a camera, or a webcam, thereby reducing or eliminating the cost for installing such hardware on the command terminal. Moreover, the utility of IM applications on a command terminal will not be affected by the immobility of the command terminal, thereby increasing the convenience of using the IM applications and the applications' rate of utilization.

Some or all of the steps of the embodiments concerning a method for transmitting information, such as those illustrated in FIGS. 1-7 and described in detail hereinabove, can be carried out by executing a program. The program can be stored in a computer-readable storage medium. Accordingly, the present disclosure discloses a computer-readable storage medium in accordance with various embodiments.

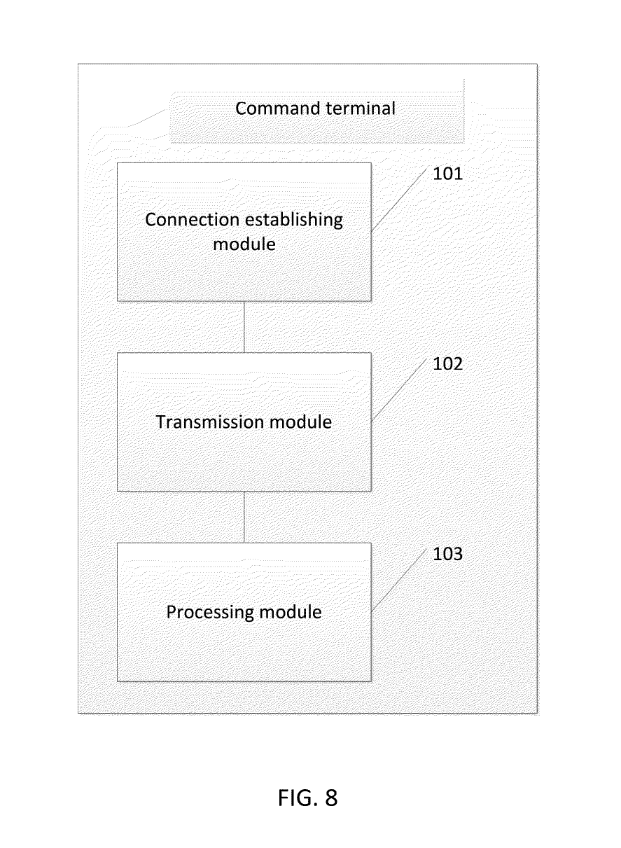

FIGS. 8-10 illustrate exemplary arrangements of a command terminal according to various embodiments. The command terminals illustrated in FIGS. 8-10 and described below can be used in the various methods described in detail hereinabove.

FIG. 8 is a schematic diagram illustrating an example of an arrangement of a command terminal according to various embodiments. The command terminal comprises: a connection establishing module 101, a transmission module 102, and a processing module 103.

The connection establishing module 101 establishes a communication connection between the command terminal and an execution terminal when the command terminal, into which an IM message is entered, detects an information transmission request from the execution terminal.

The transmission module 102 receives multimedia information, which was obtained by and sent from the execution terminal.

The processing module 103 inserts the multimedia information into the IM message.

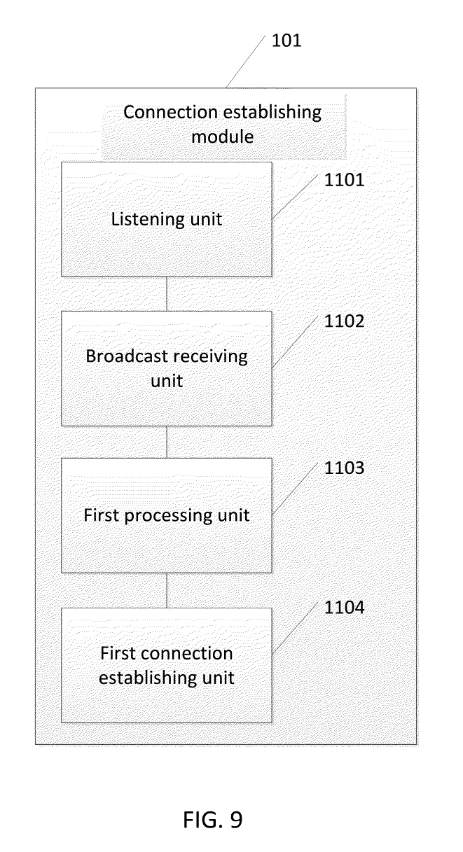

FIG. 9 is a schematic diagram illustrating an example of an arrangement of the connection establishing module illustrated in FIG. 8. The connection establishing module 101 comprises: a listening unit 1101, a broadcast receiving unit 1102, a first processing unit 1103, and a first connection establishing unit 1104.

The listening unit 1101 listens to a LAN communication port.

The broadcast receiving unit 1102 receives from the execution terminal, via the LAN communication port, a first broadcast data packet. The first broadcast data packet contains secret key information associated with the command terminal and address information associated with the execution terminal. Alternatively, the broadcast receiving unit 1102 receives from the execution terminal and via the LAN communication port an encrypted second broadcast data packet. The encrypted second broadcast data packet contains address information associated with the execution terminal.

The first processing unit 1103 extracts the secret key information from the first broadcast data packet and verifies it. Alternatively, it decrypts the encrypted second broadcast data packet by using secret key information associated with the command terminal.

The first connection establishing unit 1104, after successful verification and by utilizing the address information associated with the execution terminal that is included in the first broadcast data packet, returns a first response data packet to the execution terminal and establishes a communication connection between the command terminal and the execution terminal. Alternatively, after successful decryption, by utilizing the address information associated with the execution terminal that is included in the second broadcast data packet, it returns a second response data packet to the execution terminal and establishes a communication connection between the command terminal and the execution terminal.

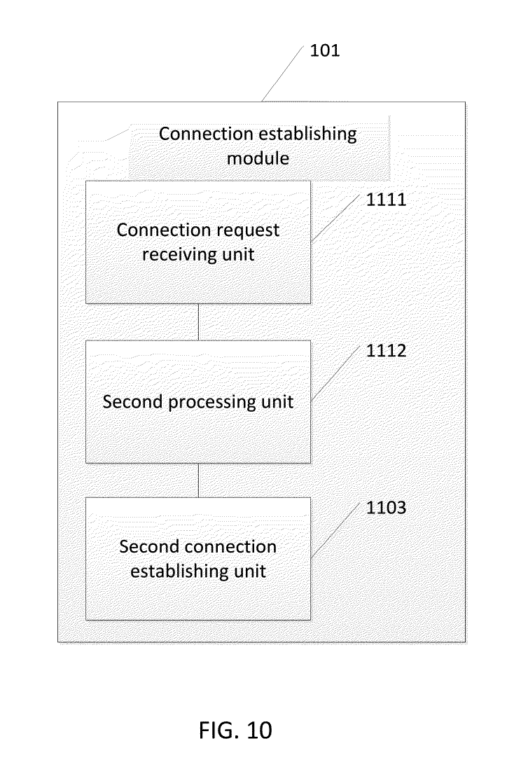

FIG. 10 is a schematic diagram illustrating another example of an arrangement of the connection establishing module illustrated in FIG. 8. The connection establishing module 101 comprises: a connection request receiving unit 1111, a second processing unit 1112, and a second connection establishing unit 1113.

The connection request receiving unit 1111 receives from an execution terminal a first connection request data packet, which contains secret key information associated with the command terminal and address information associated with the execution terminal. Alternatively, it receives from the execution terminal an encrypted second connection request data packet, which contains address information associated with the execution terminal.

The second processing unit 1112 extracts the secret key information from the first connection request data packet and verifies it. Alternatively, it decrypts the encrypted second connection request data packet by using secret key information associated with the command terminal.

The second connection establishing unit 1113, after successful verification and by utilizing the address information associated with the execution terminal that is included in the first connection request data packet, returns a first connection response data packet to the execution terminal and establishes a communication connection between the command terminal and the execution terminal. Alternatively, after successful decryption and by utilizing the address information associated with the execution terminal that is included in the second connection request data packet, it returns a second connection response data packet to the execution terminal and establishes a communication connection between the command terminal and the execution terminal.

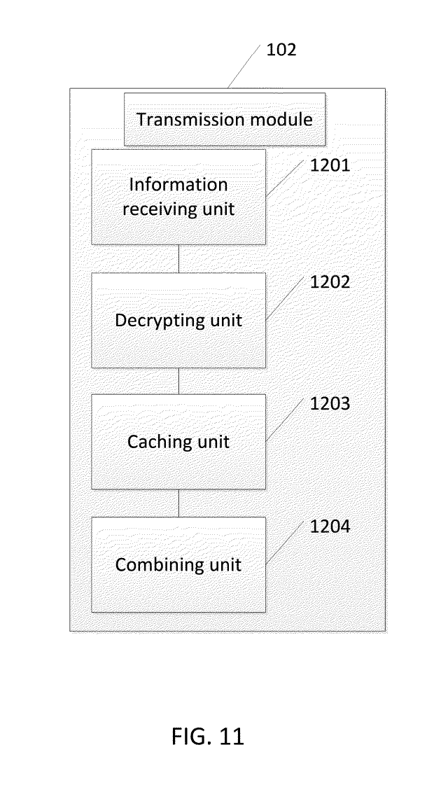

FIG. 11 is a schematic diagram illustrating an example of an arrangement of the transmission module illustrated in FIG. 8. The transmission module 102 comprises: an information receiving unit 1201, a decrypting unit 1202, a caching unit 1203, and a combining unit 1204.

The information receiving unit 1201 receives currently recorded and encrypted multimedia information from an execution terminal.

The decrypting unit 1202 uses secret key information associated with the command terminal to decrypt the currently recorded and encrypted multimedia information.

The caching unit 1203 caches the decrypted multimedia information.

The combining unit 1204, upon receiving from the execution terminal a notification indicating that recording is complete, combines the cached multimedia information to generate complete multimedia information.

In this example, the processing module 103 inserts the complete multimedia information into the IM message that is entered into the command terminal.

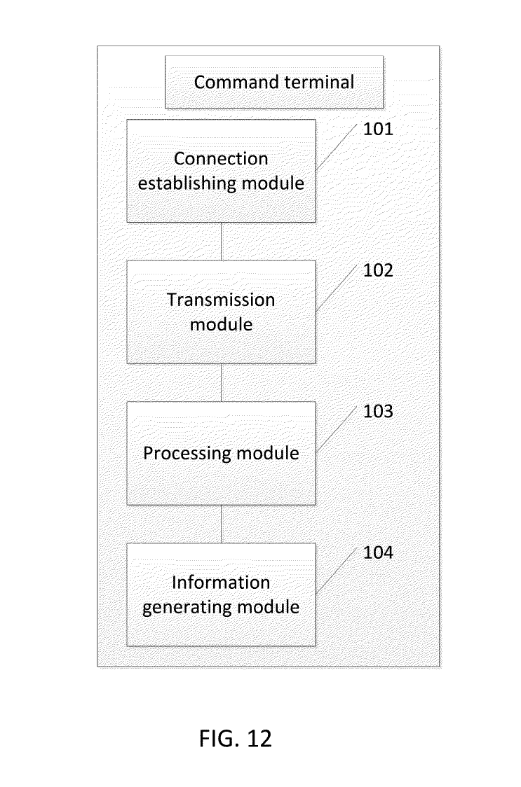

FIG. 12 is a schematic diagram illustrating another example of an arrangement of a command terminal according to various embodiments. The command terminal comprises: a connection establishing module 101, a transmission module 102, a processing module 103, and an information generating module 104. The structures and functions of the connection establishing module 101, the transmission module 102, and the processing module 103 are described in the embodiments shown in FIGS. 8-11 and are not repeated here.

The information generating module 104 generates a 2D code in accordance with secret key information associated with the command terminal; or generates a random string in accordance with secret key information associated with the command terminal; or generates a 2D code in accordance with secret key information and address information associated with the command terminal; or generates a random string in accordance with secret key information and address information associated with the command terminal.

The functionalities of various modules within the command terminal described above can be implemented based on early descriptions of embodiments concerning a method for transmitting information and are not repeated here.

The above description of various embodiments illustrates that a command terminal, into which an IM message is entered, can establish a communication connection with an execution terminal for transmitting multimedia information. As a result, the command terminal can obtain multimedia information recorded by the execution terminal and insert the multimedia information into the IM message. Thus, the command terminal can take advantage of the multimedia features in IM applications without installing additional recording hardware, such as a microphone or a webcam, thereby reducing or eliminating the cost for installing such hardware on the command terminal. Moreover, the utility of IM applications on a command terminal will not be affected by the immobility of the command terminal, thereby increasing the convenience of using the IM applications and the applications' rate of utilization.

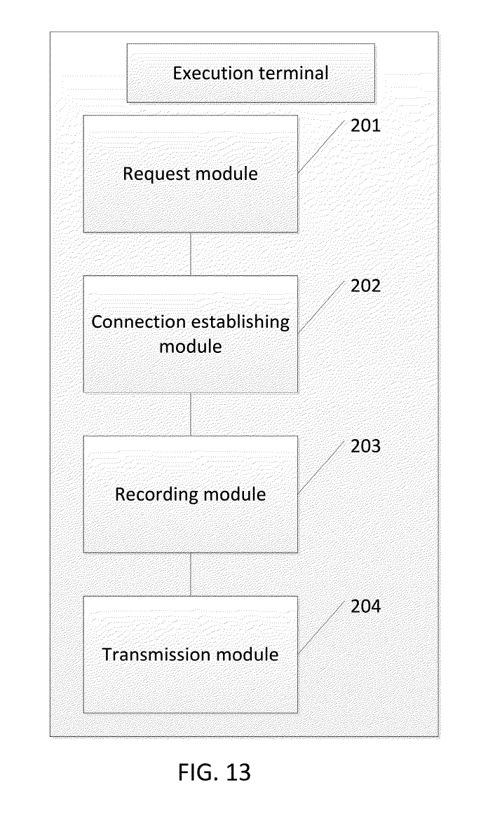

FIGS. 13-16 illustrate exemplary arrangements of an execution terminal according to various embodiments. The execution terminals illustrated in FIGS. 13-16 and described below can be used in the various methods described in detail hereinabove.

FIG. 13 is a schematic diagram illustrating an example of an arrangement of an execution terminal according to various embodiments. The execution terminal comprises: a request module 201, a connection establishing module 202, a recording module 203, and a transmission module 204.

The request module 201 sends an information transmission request to a command terminal, into which an IM message is entered.

The connection establishing module 202 establishes a communication connection between the execution terminal and the command terminal.

The recording module 203 activates recording hardware to start recording multimedia information after the communication connection between the execution terminal and the command terminal is established.

The transmission module 204 sends the multimedia information to the command terminal, enabling the command terminal to insert the multimedia information into the IM message.

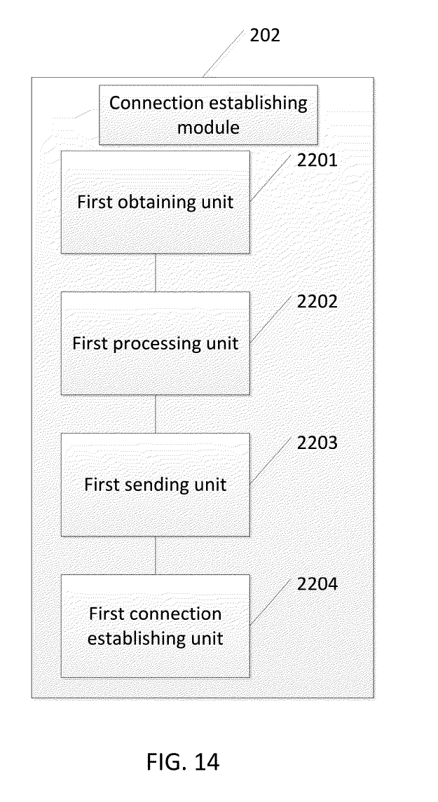

FIG. 14 is a schematic diagram illustrating an example of an arrangement of the connection establishing module illustrated in FIG. 13. The connection establishing module 202 comprises: a first obtaining unit 2201, a first processing unit 2202, a first sending unit 2203, and a first connection establishing unit 2204.

The first obtaining unit 2201 obtains secret key information associated with a command terminal.

According to some embodiments, the first obtaining unit 2201 scans a 2D code generated by the command terminal to obtain the secret key information associated with the command terminal. According to some other embodiments, the first obtaining unit 2201 receives a random string entered by a user to obtain the secret key information associated with the command terminal.

The first processing unit 2202 generates a first broadcast data packet, which contains the secret key information associated with the command terminal and address information associated with the execution terminal; alternatively, it uses the secret key information associated with the command terminal to encrypt a second broadcast data packet, which contains address information associated with the execution terminal.

The first sending unit 2203 sends the first broadcast data packet or the encrypted second broadcast data packet to a LAN communication port.

The first connection establishing unit 2204 receives a first response data packet, which was sent from the command terminal in response to the first broadcast data packet, and establishes a communication connection between the execution terminal and the command terminal; alternatively, it receives a second response data packet, which was sent from the command terminal in response to the encrypted second broadcast data packet, and establishes a communication connection between the execution terminal and the command terminal.

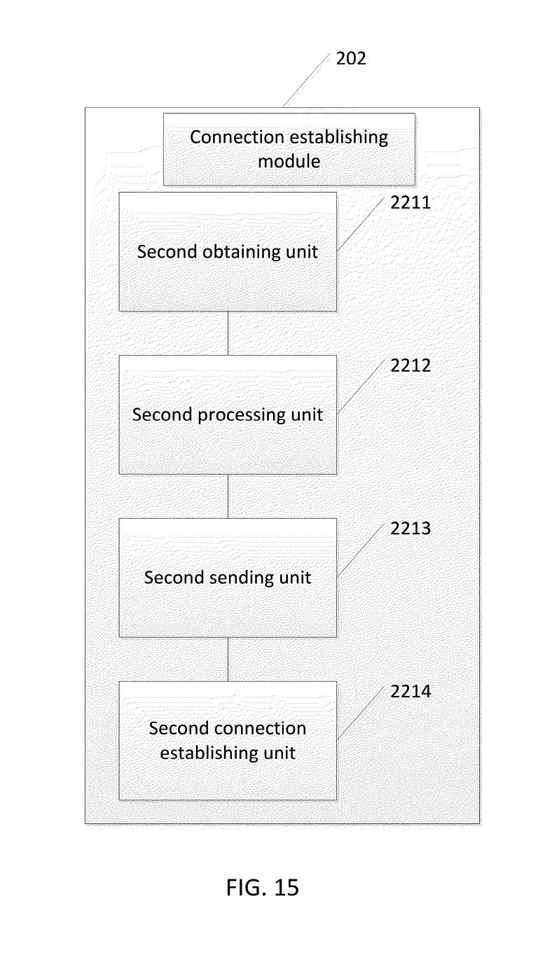

FIG. 15 is a schematic diagram illustrating another example of an arrangement of the connection establishing module illustrated in FIG. 13. The connection establishing module 202 comprises: a second obtaining unit 2211, a second processing unit 2212, a second sending unit 2213, and a second connection establishing unit 2214.

The second obtaining unit 2211 obtains secret key information and address information associated with a command terminal.

According to some embodiments, the second obtaining unit 2211 scans a 2D code generated by the command terminal to obtain the secret key information and the address information associated with the command terminal. According to some embodiments, the second obtaining unit 2211 receives a random string entered by a user to obtain the secret key information and the address information associated with the command terminal.

The second processing unit 2212 generates a first connection request data packet, which contains the secret key information associated with the command terminal and address information associated with the execution terminal; alternatively, it uses the secret key information associated with the command terminal to encrypt a second connection request data packet, which contains address information associated with the execution terminal.

The second sending unit 2213 sends the first connection request data packet or the encrypted second connection request data packet in accordance with the address information associated with the command terminal.

The second connection establishing unit 2214 receives a first connection response data packet, which was sent from the command terminal in response to the first connection request data packet, and establishes a communication connection between the execution terminal and the command terminal; alternatively, it receives a second connection response data packet, which was sent from the command terminal in response to the encrypted second connection request data packet, and establishes a communication connection between the execution terminal and the command terminal.

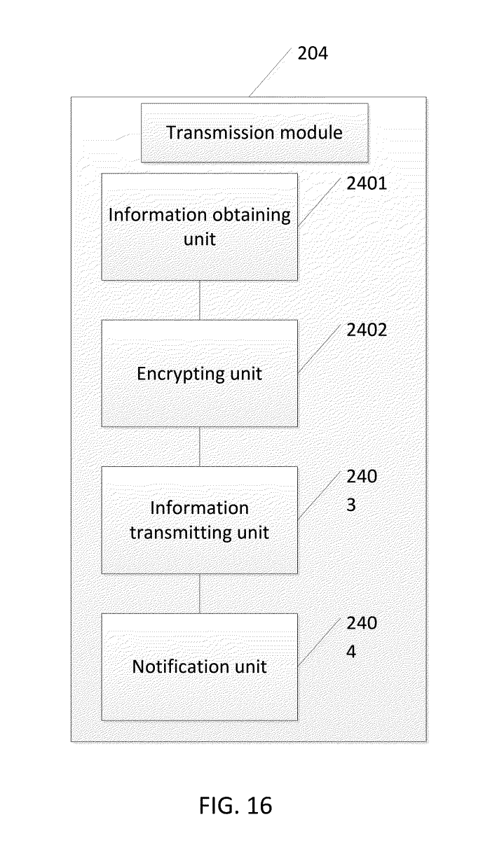

FIG. 16 is a schematic diagram illustrating an example of an arrangement of the transmission module illustrated in FIG. 13. The transmission module 204 comprises: an information obtaining unit 2401, an encrypting unit 2402, an information transmitting unit 2403, and a notification unit 2404.

The information obtaining unit 2401 obtains multimedia information currently recorded by a recording device associated with the execution terminal.

The encrypting unit 2402 uses secret key information associated with a command terminal to encrypt the currently recorded multimedia information.

The information transmitting unit 2403 sends the encrypted multimedia information to the command terminal, enabling the command terminal to decrypt the encrypted multimedia information using the secret key information associated with the command terminal, and to cache the decrypted multimedia information.

The notification unit 2404, upon determining that recording of the multimedia information is complete, sends a notification to the command terminal indicating that the recording has ended, enabling the command terminal to combine the cached multimedia information to generate complete multimedia information.

The functionalities of various modules within the execution terminal described above can be implemented based on early descriptions of embodiments concerning a method for transmitting information and are not repeated here.

The above description of embodiments illustrates that a command terminal, into which an IM message is entered, can establish a communication connection with an execution terminal for transmitting multimedia information. As a result, the command terminal can obtain multimedia information recorded by the execution terminal and insert the multimedia information into the IM message. Thus, the command terminal can take advantage of the multimedia features in IM applications without installing additional recording hardware, such as a microphone, a camera, or a webcam, thereby reducing or eliminating the cost for installing such hardware on the command terminal. Moreover, the utility of IM applications on a command terminal will not be affected by the immobility of the command terminal, thereby increasing the convenience of using the IM applications and the applications' rate of utilization.

The present disclosure concerns situations where one terminal can connect to another terminal, and acquire functionalities of the other terminal, such as multimedia recording functionalities. For example, a PC can connect to a mobile device, such as a smart phone, to activate, directly or indirectly, recording hardware on the smart phone to record multimedia information. Then, the PC can use the multimedia information in software applications, such as inserting the multimedia information into a message in an instant messaging application. Similarly, a PC can connect to another PC, which has recording hardware installed. The first PC can then activate the recording hardware on the second PC to record multimedia information, and use the multimedia information in software applications, such as inserting the multimedia information into a message in an instant messaging application, on the first PC. Therefore, although embodiments disclosed herein may be described and illustrated herein in terms of a mobile terminal transmitting multimedia information to a PC terminal via wireless connection, it should be understood that the embodiments are not so limited, but can be additionally applicable to any terminal, any file, and any connection, i.e., any inter-terminal information sharing via any form(s) of connection between the terminals. For example, the two terminals can be on the same LAN via either a wireless connection to an Access Point (“AP”) or a wired connection to a switch and/or a router. For example, a PC can be connected to a mobile phone via the AP on a LAN. Alternatively, if the PC cannot connect directly to the AP, then the PC can be connected to a switch and/or router in the LAN, which connects to the AP that is connected to the mobile phone. Examples of inter-terminal methods of connection are well known to those skilled in the art, and includes, but are not limited to, via the Internet, a LAN (wired or wireless or both), mobile phone communication networks such as GSM, CDMA, TDMA, EDGE, GPRS, 2G, 3G, LTE, 4G, or any other method connecting two terminals, such as via a WiFi network, or such short-distance direct wireless connections as Bluetooth, infrared, or near field communication. Similarly, the connection between a terminal and a server can be via the Internet, a LAN (wired or wireless or both), mobile phone communication networks such as GSM, CDMA, TDMA, EDGE, GPRS, 2G, 3G, LTE, 4G, or any other method connecting a terminal to a server, which methods are also well known to those skilled in the art.

Although embodiments disclosed herein may be described and illustrated herein in terms of one terminal transmitting multimedia information to another terminal, it should be understood that the embodiments are not so limited, but can be additionally applicable to the transmission of multimedia information from one execution terminal to a plurality of command terminals, or from a plurality of execution terminals to one command terminal. In these embodiments, communication connections can be established between the one command terminal and each one of the plurality of execution terminals or between the one execution terminal and each of the plurality of the command terminals in accordance with the methods described herein. There are certain advantages to such one-to-many and many-to-one connection topologies. For example, users of more than one command terminal may wish to insert multimedia information broadcast by one execution terminal into one or more IM messages in IM applications running on each of the more than one command terminal. In other cases, a user of a command terminal may wish to insert multimedia information sent from different execution terminals into one or more IM messages in an IM application running on a command terminal. Methods of creating such one-to-many and many-to-one connection topologies are well known to those skilled in the art. Using the methods disclosed herein, multimedia information can be transmitted across a certain connection topology and inserted into IM messages entered into one or more command terminals in a certain connection topology.

According to some embodiments, multimedia information sent from an execution terminal to a command terminal can comprise different forms of information. By way of example only, an execution terminal can associate audio information with image information and send both pieces of information to a command terminal, either simultaneously or consecutively. The audio information can either be audio information previously stored in a storage space of the execution terminal or audio information being recorded by the execution terminal, e.g., by voice recording function of the execution terminal such as an integrated microphone of a mobile phone. Similarly, the image information can either be image information previous stored in a storage space of the execution terminal or image information being recorded by the execution terminal, e.g., by image capturing function of the execution terminal such as an integrated camera of a mobile phone. When the command terminal receives both pieces of information, the command terminal can separate them and insert only one piece of information into an IM message. Alternatively, the command terminal can insert both pieces of information as a whole into an IM message.

The following is a specific example illustrating an embodiment of an information transmission method in accordance with the present disclosure.

A user may wish to insert a picture with audio narration into an IM message entered into a PC. She can use a mobile phone to take a picture and/or record a piece of audio narration. The mobile phone can then send multimedia information comprising both the picture and the audio narration to the PC, which can insert the received picture and audio narration into an IM message.

The following is another specific example illustrating an embodiment of an information transmission method in accordance with the present disclosure.

A user may wish to add watermark or an image overlay to a video being recorded by an execution terminal before sending the video information from the execution terminal to a command terminal. The execution terminal can add the overlay and send the video information with the image overlay to the command terminal, which can then insert the video information with the image overlay to an IM message.

According to some embodiments, an execution terminal can perform one or more of various operations to multimedia information before sending the multimedia information to a command terminal. By way of example only, if the multimedia information is text information, the execution terminal can allow a user of the execution terminal to edit the text information before sending it to a command terminal. If the multimedia information is image information such as a digital picture, the execution terminal can perform such image editing operations as cropping, sharpening, adjusting the brightness, adjusting the contrast, changing from color to greyscale, red-eye removal, and adding text or voice to the image information. If the multimedia information is video information, the execution terminal can perform such editing operations as adjusting the brightness, adjusting the contrast, changing from color to greyscale or any other color theme or mode, and adding text such as subtitles or image overlay such as watermark to the video information.

According to some embodiments, upon receipt of the multimedia information, the command terminal can, either automatically or following user command upon prompt by the terminal, perform certain operation(s) on the received multimedia information to convert it to a different form and then insert the multimedia information in the converted form into an IM message.

According to some embodiments, if the multimedia information is a piece of audio information, e.g., in the form of an audio file recognizable by the command terminal, the command terminal can perform, either automatically or following user command upon prompt by the command terminal, voice recognition on the audio information and recognize whether there is any human voice in the audio information. According to some embodiments, the voice recognition can be performed by an IM application itself. According to some other embodiments, the voice recognition can be performed by the IM application calling another application with voice-recognition function. According to some embodiments, the other application with voice-recognition function can be installed on the same terminal as the IM application. According to some other embodiments, the voice-recognition function can be provided by a terminal different from the terminal on which the IM application is installed. According to yet some other embodiments, the voice-recognition function can be provided by a server. Methods of voice recognition are well-known to those skilled in the art.

According to some embodiments, after an IM application or another application with voice-recognition function has detected that the received multimedia information contains human voice, the command terminal can perform, either automatically or following user command upon prompt by the command terminal, a speech-to-text operation to convert any speech contained in the human voice to text. The IM application can then insert the converted text into an IM message. According to some embodiments, the speech-to-text operation can be performed by the IM application itself. According to some other embodiments, the speech-to-text operation can be provided by the IM application calling another application with speech-to-text function. According to some embodiments, the other application with text-to-speech function can be installed on the same terminal as the IM application. According to some other embodiments, the text-to-speech function can be provided by a terminal different from the terminal on which the IM application is installed. According to yet some other embodiments, the text-to-speech function can be provided by a server. Methods of text-to-speech conversion are well-known to those skilled in the art.

According to some embodiments, if the multimedia information is a piece of image information comprising text information, e.g., in the form of an image file recognizable by the command terminal, wherein the image comprises text in it, such as a picture of a newspaper article taken by a digital camera on a mobile phone, the command terminal can perform, either automatically or following user command upon prompt by the command terminal, text recognition on the image information and recognize whether there is any text in any written language in the image information. According to some embodiments, the text recognition can be performed by an IM application itself. According to some other embodiments, the text recognition can be performed by the IM application calling another application with text-recognition function. According to some embodiments, the other application with text-recognition function can be installed on the same terminal as the IM application. According to some other embodiments, the text-recognition function can be provided by a terminal different from the terminal on which the IM application is installed. According to yet some other embodiments, the text-recognition function can be provided by a server. Methods of text recognition are well-known to those skilled in the art.

According to some embodiments, after an IM application or another application with text-recognition function has detected that the received multimedia information contains text in any written language, the command terminal can perform, either automatically or following user command upon prompt by the command terminal, an optical character recognition (“OCR”) operation to convert any text information contained in the image information to text. The IM application can then insert the converted text into an IM message. According to some embodiments, the OCR operation can be performed by the IM application itself. According to some other embodiments, the OCR operation can be provided by the IM application calling another application with OCR function. According to some embodiments, the other application with OCR function can be installed on the same terminal as the IM application. According to some other embodiments, the OCR function can be provided by a terminal different from the terminal on which the IM application is installed. According to yet some other embodiments, the OCR function can be provided by a server. Methods of OCR are well-known to those skilled in the art.

According to some embodiments, if the multimedia information is a piece of text information, e.g., in the form of a text file recognizable by the command terminal, the command terminal can perform, either automatically or following user command upon prompt by the command terminal, text-to-speech conversion on the text information and convert the text information into audio information comprising speech. According to some embodiments, the text-to-speech conversion can be performed by an IM application itself. According to some other embodiments, the text-to-speech conversion can be performed by the IM application calling another application with text-to-speech conversion function. According to some embodiments, the other application with text-to-speech conversion function can be installed on the same terminal as the IM application. According to some other embodiments, the text-to-speech conversion function can be provided by a terminal different from the terminal on which the IM application is installed. According to yet some other embodiments, the text-to-speech conversion function can be provided by a server. Methods of text-to-speech conversion are well-known to those skilled in the art.

According to some embodiments, the above-mentioned conversions of the form of multimedia information, e.g., the conversion of audio information containing human voice into text, the conversion of image information containing text information into text, or text-to-speech conversion, are performed on the execution terminal or another terminal different from the command terminal, such that the multimedia information from the execution terminal to the command terminal, either directly or via a server, is in the converted form already, and the command terminal can insert the received information into an IM message without any further conversion, regardless of any combination processing performed by the command terminal to combine all cached multimedia information it has received, if any. Methods of OCR on a mobile terminal described in PCT/CN2013/080384, the contents of which are incorporated by reference herein in their entirety for all purposes. Methods of text-to-speech conversion on a mobile terminal are well-known to those skilled in the art.

According to some embodiments, a command terminal has decoding capability with regard to the multimedia information from an execution terminal. According to these embodiments, the multimedia information sent from the execution terminal to the command terminal do not have to be decoded on the execution terminal before being sent to the command terminal. According to some other embodiments, a command terminal does not have to have decoding capability with regard to multimedia information sent to it from an execution terminal. According to these embodiments, the multimedia information from the execution terminal to the command terminal can be decoded on the execution terminal before being sent to the command terminal. Methods of decoding multimedia information on a command terminal or an execution terminal are well known to those skilled in the art. Those skilled in the art will readily appreciate that the transmission of a decoded multimedia file can take longer than the transmission of the same multimedia file before decoding due to increased file size as a result of the decoding process. In addition, decoding a multimedia file, particularly a video file, on a mobile terminal can consume considerable processing power. Therefore, a preferred embodiment, especially in the case of sending an audio or video file to a command terminal, is for the command terminal to have decoding capability and to transfer the audio or video file from the execution terminal to the command terminal without being decoded before the transfer.

Those skilled in the art will readily appreciate that where ordinal numbers such as “first” and “second” are used herein, they serve to distinguish and identify different terminals, data requests, and units, as applicable, with similar names, but do not imply any similarity in either function or order, temporal, spatial, or otherwise.

Persons of ordinary skill in the art can readily appreciate that all or part of the steps of the methods described in the embodiments above can be executed by relevant hardware instructed by a program that may be stored in a computer-readable memory medium. The readable memory medium may be, for example, a read-only memory (“ROM”), a random access memory (“RAM”), a magnetic disk, or a compact disc.

Although the disclosed embodiments have been fully described with reference to the accompanying drawings, it is to be noted that various changes and modifications will become apparent to those skilled in the art. Such changes and modifications are to be understood as being included within the scope of the disclosed embodiments as defined by the appended claims.

What is claimed is:

1. An information transmission method comprising:
detecting an information transmission request from an execution terminal,
establishing a communication connection between the execution terminal and a command terminal,
receiving multimedia information from the execution terminal, and
inserting the received multimedia information into an IM message.

2. The method of claim 1, wherein establishing the communication connection between the execution terminal and the command terminal comprises:
sending secret key information to the execution terminal, enabling the execution terminal to send a first broadcast data packet to a LAN communication port, the first broadcast data packet carrying the secret key information and address information associated with the execution terminal,
listening to the LAN communication port,
receiving the first broadcast data packet from the LAN communication port,
extracting the secret key information from the first broadcast data packet,
verifying the extracted secret key information, and
sending a first response data packet to the execution terminal in accordance with the address information in the first broadcast data packet.

3. The method of claim 1, wherein establishing the communication connection between the execution terminal and the command terminal comprises:
sending secret key information to the execution terminal, enabling the execution terminal to encrypt a second broadcast data packet using the secret key information, the second broadcast data packet carrying address information associated with the execution terminal, and to send the second broadcast data packet to a LAN communication port,
listening to the LAN communication port,
receiving the encrypted second broadcast data packet from the LAN communication port,
decrypting the encrypted second broadcast data packet using the secret key information, and
sending a second response data packet to the execution terminal in accordance with the address information associated with the execution terminal in the second broadcast data packet.

4. The method of claim 1, wherein establishing the communication connection between the execution terminal and the command terminal comprises:
sending secret key information and address information associated with the command terminal to the execution terminal,
receiving a first connection request data packet from the execution terminal, wherein the first connection request data packet is sent from the execution terminal in accordance with the address information associated with the command terminal and the first connection request data packet comprises the secret key information and address information associated with the execution terminal,
extracting the secret key information from the first connection request data packet,
verifying the extracted secret key information, and
sending a first connection response data packet to the execution terminal in accordance with the address information associated with the execution terminal in the first connection request data packet.

5. The method of claim 1, wherein establishing the communication connection between the execution terminal and the command terminal comprises:
sending secret key information and address information associated with the command terminal to the execution terminal, enabling the execution terminal to encrypt a second connection request data packet using the secret key information, the second connection request data packet carrying address information associated with the execution terminal,
receiving the encrypted second connection request data packet, wherein the encrypted second connection request data packet is sent in accordance with the address information associated with the command terminal,
decrypting the encrypted second connection request data packet using the secret key information, and
sending a second connection response data packet to the execution terminal in accordance with the address information associated with the execution terminal in the second connection request data packet.

6. The method of claim 1, wherein the multimedia information is recorded by the execution terminal, wherein the method comprises:
caching the received recorded multimedia information,
receiving notification that recording of the multimedia information is complete from the execution terminal, and
combining the cached multimedia information, thereby generating complete multimedia information, and
wherein inserting the received multimedia information into the IM message comprises inserting the complete multimedia information into the IM message.

7. An information transmission method comprising:
sending an information transmission request to a command terminal into which an IM message is entered,
establishing a communication connection between an execution terminal and the command terminal,
recording multimedia information, and
sending the recorded multimedia information to the command terminal, enabling the command terminal to receive the recorded multimedia information and to insert the received recorded multimedia information into the IM message.

8. The method of claim 7, wherein establishing the communication connection between the execution terminal and the command terminal comprises:
receiving secret key information associated with the command terminal,
sending a first broadcast data packet to a LAN communication port, the first broadcast data packet carrying the secret key information associated with the command terminal and address information associated with the execution terminal, enabling the command terminal to receive the first broadcast data packet by listening to the LAN communication port, to extract the secret key information from the first broadcast data packet, and to verify the extracted secret key information, and
receiving a first response data packet from the command terminal, wherein the first response data packet is sent from the command terminal in accordance with the address information associated with the execution terminal.

9. The method of claim 7, wherein establishing the communication connection between the execution terminal and the command terminal comprises:
receiving secret key information associated with the command terminal,
encrypting a second broadcast data packet using the secret key information associated with the command terminal, the second broadcast data packet carrying address information associated with the execution terminal,
sending the encrypted second broadcast data packet to a LAN communication port, enabling the command terminal to receive the encrypted second broadcast data packet by listening to the LAN communication port and to decrypt the encrypted second broadcast data packet using the secret key information associated with the command terminal, and
receiving a second response data packet from the command terminal, wherein the second response data packet is sent from the command terminal in accordance with the address information associated with the execution terminal.

10. The method of claim 7, wherein establishing the communication connection between the execution terminal and the command terminal comprises:
obtaining secret key information associated with the command terminal and address information associated with the command terminal,
sending a first connection request data packet to the command terminal in accordance with the address information associated with the command terminal, the first connection request data packet comprising the secret key information associated with the command terminal and address information associated with the execution terminal, enabling the command terminal to extract the secret key information from the first connection request data packet and to verify the extracted secret key information, and
receiving a first connection response data packet from the command terminal, wherein the first connection response data packet is sent from the command terminal in accordance with the address information associated with the execution terminal in the first connection request data packet.

11. The method of claim 7, wherein establishing the communication connection between the execution terminal and the command terminal comprises:
obtaining secret key information associated with the command terminal and address information associated with the command terminal,
encrypting a second connection request data packet using the secret key information, the second connection request data packet carrying address information associated with the execution terminal,
sending the encrypted second connection request data packet to the command terminal in accordance with the address information associated with the command terminal, enabling the command terminal to decrypt the encrypted second connection request data packet using the secret key information associated with the command terminal, and
receiving a second connection response data packet from the command terminal, wherein the second connection response data packet is sent from the command terminal in accordance with the address information associated with the execution terminal in the second connection request data packet.

12. The method of claim 7, comprising:
encrypting the recorded multimedia information,
wherein sending the multimedia information to the command terminal comprises:
sending the encrypted multimedia information to the command terminal, enabling the command terminal to decrypt the encrypted multimedia information and to insert the decrypted multimedia information into the IM message.

13. The method of claim 7, wherein recording the multimedia information comprises recording the multimedia information in more than one multimedia information packet, and sending the multimedia information to the command terminal comprises sending the more than one multimedia information packet to the command terminal, enabling the command terminal to cache the more than one multimedia information packet, to combine the cached more than one multimedia packet to generate complete multimedia information, and to insert the complete multimedia information into the IM message.

14. A command terminal comprising:
a connection establishing module that establishes a communication connection between the command terminal and an execution terminal, when the command terminal, into which an IM message is entered, detects an information transmission request from the execution terminal,
a transmission module that receives multimedia information obtained by and sent from the execution terminal, and
a processing module that inserts the multimedia information into the IM message.

15. The command terminal according to claim 14, wherein the connection establishing module comprises:
a listening unit that listens to a LAN communication port,
a broadcast receiving unit that either receives from the execution terminal and via the LAN communication port a first broadcast data packet carrying secret key information associated with the command terminal and address information associated with the execution terminal or receives from the execution terminal and via the LAN communication port an encrypted second broadcast data packet carrying the address information associated with the execution terminal,
a first processing unit that either extracts the secret key information associated with the command terminal from the first broadcast data packet and verifies the extracted secret key information or decrypts the encrypted second broadcast data packet by using the secret key information associated with the command terminal, and
a first connection establishing unit that either, after successful verification and by utilizing the address information associated with the execution terminal in the first broadcast data packet, returns a first response data packet to the execution terminal and establishes the communication connection between the command terminal and the execution terminal or, after successful decryption and by utilizing the address information associated with the execution terminal in the second broadcast data packet, returns a second response data packet to the execution terminal and establishes the communication connection between the command terminal and the execution terminal.

16. The command terminal according to claim 14, wherein the connection establishing module comprises:
a connection request receiving unit that either receives from the execution terminal a first connection request data packet carrying secret key information associated with the command terminal and address information associated with the execution terminal or receives from the execution terminal an encrypted second connection request data packet carrying the address information associated with the execution terminal,
a second processing unit that either extracts the secret key information associated with the command terminal from the first connection request data packet and verifies the extracted secret key information or decrypts the encrypted second connection request data packet by using the secret key information associated with the command terminal, and
a second connection establishing unit that either, after successful verification and by utilizing the address information associated with the execution terminal in the first connection request data packet, returns a first connection response data packet to the execution terminal and establishes the communication connection between the command terminal and the execution terminal or, after successful decryption and by utilizing the address information associated with the execution terminal in the second connection request data packet, returns a second connection response data packet to the execution terminal and establishes the communication connection between the command terminal and the execution terminal.

17. The command terminal according to claim 14, wherein the transmission module comprises:
an information receiving unit that receives currently recorded and encrypted multimedia information from the execution terminal,
a decrypting unit that uses secret key information associated with the command terminal to decrypt the currently recorded and encrypted multimedia information,
a caching unit that caches the decrypted multimedia information, and
a combining unit that, upon receiving from the execution terminal a notification indicating that recording is complete, combines the cached multimedia information to generate complete multimedia information, and
wherein the processing module inserts the complete multimedia information into the IM message.

18. An execution terminal comprising:
a request module that sends an information transmission request to a command terminal, into which an IM message is entered,
a connection establishing module that establishes a communication connection between the execution terminal and the command terminal,
a recording module that activates recording hardware to start recording multimedia information after the communication connection between the execution terminal and the command terminal is established, and
a transmission module that sends the multimedia information to the command terminal, enabling the command terminal to insert the multimedia information into the IM message.

19. The execution terminal according to claim 18, wherein the connection establishing module comprises:
a first obtaining unit that obtains secret key information associated with the command terminal;
a first processing unit that either generates a first broadcast data packet carrying the secret key information associated with the command terminal and address information associated with the execution terminal or uses the secret key information associated with the command terminal to encrypt a second broadcast data packet carrying the address information associated with the execution terminal,
a first sending unit that either sends the first broadcast data packet to a LAN communication port or sends the encrypted second broadcast data packet to the LAN communication port, and
a first connection establishing unit that either receives a first response data packet from the command terminal, wherein the first response data packet is sent from the command terminal in response to the first broadcast data packet, and establishes the communication connection between the execution terminal and the command terminal or receives a second response data packet from the command terminal, wherein the second response data packet is sent from the command terminal in response to the encrypted second broadcast data packet, and establishes the communication connection between the execution terminal and the command terminal.

20. The execution terminal according to claim 18, wherein the connection establishing module comprises:
a second obtaining unit that obtains secret key information and address information associated with the command terminal,
a second processing unit that either generates a first connection request data packet carrying the secret key information associated with the command terminal and address information associated with the execution terminal or uses the secret key information associated with the command terminal to encrypt a second connection request data packet carrying the address information associated with the execution terminal,
a second sending unit that either sends the first connection request data packet in accordance with the address information associated with the command terminal or sends the encrypted second connection request data packet in accordance with the address information associated with the command terminal, and
a second connection establishing unit that either receives a first connection response data packet from the command terminal, wherein the first connection response data packet is sent from the command terminal in response to the first connection request data packet, and establishes the communication connection between the execution terminal and the command terminal, or receives a second connection response data packet from the command terminal, wherein the second connection response data packet is sent from the command terminal in response to the encrypted second connection request data packet, and establishes the communication connection between the execution terminal and the command terminal.

21. The execution terminal according to claim 18, wherein the transmission module comprises:
an information obtaining unit that obtains multimedia information currently recorded by a recording device associated with the execution terminal,
an encrypting unit that uses secret key information associated with the command terminal to encrypt the currently recorded multimedia information,
an information transmitting unit that sends the encrypted multimedia information to the command terminal, enabling the command terminal to decrypt the encrypted multimedia information using the secret key information associated with the command terminal, and to cache the decrypted multimedia information, and
a notification unit that, upon determining that recording of the multimedia information is complete, sends a notification to the command terminal indicating that the recording has ended, enabling the command terminal to combine the cached multimedia information to generate complete multimedia information.
